(19) United States
(12) Patent Application Publication
(10) Pub. No.: US 2004/0064731 A1
(43) Pub. Date: Apr. 1, 2004

(54) Integrated security administrator

(76) Inventors: Timothy Thien-Kiem Nguyen, Houston, TX (US); Martha Fischer Evert, Friendswood, TX (US); Francois Thierry Barret, Houston, TX (US)

Correspondence Address: Jonathan P. Osha, Rosenthal & Osha L.L.P., Suite 2800, 1221 McKinney Street, Houston, TX, 77010, US

(21) Appl. No.: 10/455,352

(22) Filed: Jun. 5, 2003

Related U.S. Application Data
(60) Provisional application No. 60/413,826, filed on Sep. 26, 2002.

(51) Int. Cl. G06F 11/30

(52) U.S. Cl. 713/201

(57) ABSTRACT

An Integrated Security Administrator (ISA) for managing an Informational Network (IN) includes a plurality of monitoring agents, wherein at least one of the plurality of monitoring agents is configured to obtain a plurality of events from a plurality of monitored elements, reduce the plurality of events to obtain a reduced plurality of events, select an event from the reduced plurality of events, characterize the event using stored knowledge, and respond to the event at a response level, and a core system configured to update data and instructions stored on the at least one of the plurality of monitoring agents.

### CROSS-REFERENCE TO RELATED APPLICATIONS

This application claims benefit of U.S. Provisional Application Serial No. 60/413,826, filed Sep. 26, 2002, entitled “Unified Security Supervisor,” in the names of Timothy Nguyen, Martha T. Evert, and Francois T. Barret.

### BACKGROUND OF INVENTION

Information security is becoming a concern for many enterprises and individuals. Numerous measures may be taken to secure corporate computer resources. For examples, firewalls may be used to block an attack from outside a network. FIG. 1 illustrates a typical implementation of an enterprise computer network that uses a firewall. An enterprise computer network typically includes an enterprise server (20) connected to various computer resources, such as a database (22). The enterprise server (20) is also connected to an internal corporate network (24), including desktop computers, networked printers, etc. The enterprise server (20) provides access to the Internet (26) for all resources operatively connected to the server. In this example, remote clients (28) may also connect to the enterprise computer network via the Internet (26).

Enterprise computer networks typically employ a firewall (30) as a security measure. The firewall (30) in the enterprise computer network protects the system from individuals outside the internal corporate network (24) from obtaining sensitive information, e.g., confidential files. Further, to protect sensitive information, an enterprise computer network may include anti-virus applications, certificate authorities, such as VeriSign® certificates, monitoring tools to track access to various resources, etc.

Intrusion Detection Systems (IDS's) are often used to help companies secure information on computer networks, such as enterprise computer networks. IDS's may be used to detect, identify, and stop intruders, support investigations to determine how an intruder accessed to the computer network, and stop future, similar exploits. An IDS may monitor use of such computer network resources as accounts, applications, storage media, protocols, communications ports, etc., and collect data from such computer network monitoring.

Data collected and available to IDS's may be used in order to detect future security breaches by creating databases of historical activity on the computer network. Such databases may include signatures, which describe attributes of, or sequences of actions, that typify attacks on computer networks. For example, a database available to an IDS may indicate that a certain sequence of scanned ports typically precedes a security breach. Thus, IDS's may detect anomalous user behavior or computer network activity by comparing observed activity against expected stored databases and/or profiles developed for users, groups of users, applications, or computer network resource usage. Observed user behavior or computer network activity, which falls outside the definition of normal behavior, as established by analysis of previously collected data, is considered anomalous.

Enterprise administrators also typically maintain databases of enterprise assets, including such information as: (1) the type of hardware and software on the asset; (2) the allowable software on the asset; and (3) the current “patch state” of the asset. There is much useful information in these databases that may be mined for knowledge and incident response.

Physical access systems are used by enterprises to monitor and control access to physical locations in the enterprise. Physical access systems may include a central access control server and access control tokens, such as smart cards. Physical access systems are the first point of defense for the physical infrastructure of an enterprise. The same techniques as described above may be used for physical access systems (e.g., a user's patterns of entry to and exit from a physical location, etc.).

Data mining techniques, also known as “knowledge discovery,” may be applied to data, such as data collected from computer networks, in order to detect patterns, associations, changes, and anomalies. Commonly used data mining algorithms include link analysis, clustering, association, rule abduction, deviation analysis, and sequence analysis. Such data mining algorithms provide the ability to identify or extract relevant data and provide analysts with different views of the collected data.

Multi-sensor data fusion, also known as distributed sensing, is an engineering discipline used to combine data collected from multiple sources, e.g., sensors, such as those used to collect data from computer networks. For example, data may be collected from system log-files, packet sniffers, Simple Network Management Protocol (SNMP) traps and queries, computer system user behavioral databases, computer network messages, etc. Use of multi-sensor data fusion often requires mathematical and heuristic techniques from knowledge areas such as statistics, artificial intelligence, operations research, digital signal processing, pattern recognition, cognitive psychology, information theory, and decision theory.

Multi-sensor data fusion may be used to filter raw data in order to use such raw data as support for high-level policymaking decisions by filtering large sets of collected data, and transforming and organizing filtered data into information sets. Mathematical methods used in multi-sensor data fusion include classical inference, the Dempster-Shafer method, and Bayesian mathematics.

Bayesian mathematics, often used for weather forecasting, may also be used to predict actions of people, such as users of computer networks. By observing actions of a user and evaluating the actions of the user, Bayesian mathematics may be used to forecast future actions of the user. For example, through analysis of the user's past actions (as gleaned from behavioral databases), Bayesian mathematics may be used to predict when and where the user is likely to log on, or log off, the computer network.

Proper management of computer networks, such as the one described in FIG. 1, typically entails addressing multiple issues regarding security. As noted above, network administrators execute a variety of applications to manage and secure a computer network. The network manager may also be required to monitor and address problems that may arise in the various applications within the computer network. For example, network administrators are typically required to handle provisioning for users of the computer network, e.g., accommodating new users of the computer network, handling changing user roles, etc. In some cases, the lack of integration of the various applications used to monitor an enterprise application may result in a security breach that is not detected until later, or not detected at all.

Commercial enterprises also have an interest in maintaining not only computer network security, but also in maintaining physical security for the building and other facilities and/or infrastructure owned and operated by such an enterprise. Physical access systems are often used to help maintain physical security and access for the infrastructure of the enterprise. Physical access systems typically include smart card readers, and smart cards associated with employees and visitors. Physical access systems may also include various security hardware, such motion detectors and door position indicators.

### SUMMARY OF INVENTION

In general, in one aspect the invention relates to an Integrated Security Administrator (ISA) for managing an Informational Network (IN). The ISA comprises a plurality of monitoring agents, wherein at least one of the plurality of monitoring agents is configured to obtain a plurality of events from a plurality of monitored elements, reduce the plurality of events to obtain a reduced plurality of events, select an event from the reduced plurality of events, characterize the event using stored knowledge, and respond to the event at a response level, and a core system configured to update data and instructions stored on the at least one of the plurality of monitoring agents.

In general, in one aspect the invention relates to a method of protecting an Informational Network (IN) using an Integrated Security Administrator (ISA). The method comprises a method of protecting an Informational Network (IN) using a Integrated Security Administrator (ISA), comprising obtaining a plurality of events on the IN, reducing the plurality of events to obtain a reduced plurality of events, selecting an event from the reduced plurality of events, characterizing the event using stored knowledge, and responding to the event at a response level using a result of characterizing the event.

In general, in one aspect the invention relates to an apparatus for protecting an Informational Network (IN) using an Integrated Security Administrator (ISA). The apparatus comprises means for obtaining a plurality of events on the IN, means for reducing the plurality of events to obtain a reduced plurality of events, means for selecting an event from the reduced plurality of events, means for characterizing the event using stored knowledge, and means for responding to the event at a response level using a result of characterizing the event.

Other aspects and advantages of the invention will be apparent from the following description and the appended claims.

### BRIEF DESCRIPTION OF DRAWINGS

FIG. 1 shows a typical enterprise computer network.

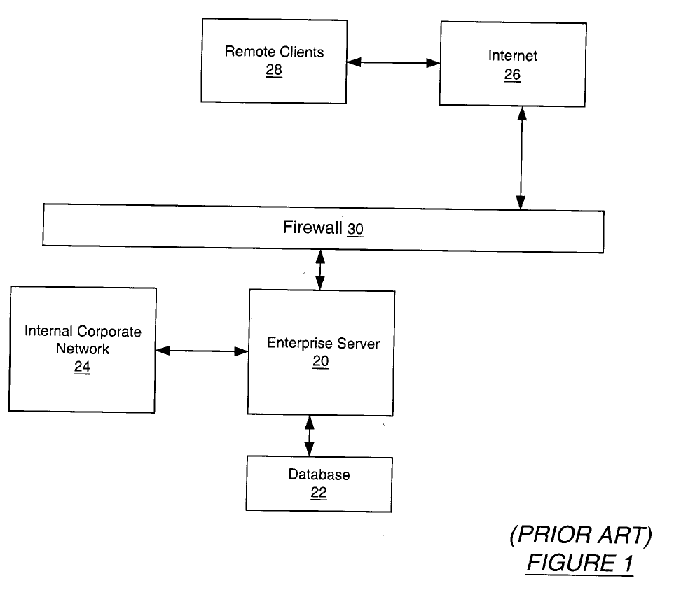

FIG. 2 shows components of an Integrated Security Administrator (ISA) in accordance with one embodiment of the invention.

FIG. 3 shows a flowchart illustrating operation of the ISA.

### DETAILED DESCRIPTION

Specific embodiments of the invention will now be described in detail with reference to the accompanying figures. Like components in the various figures are denoted by like reference numerals for consistency.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

An enterprise may protect enterprise assets, such as a computer network, by using an IDS to stop intruders from gaining access to a computer network. The IDS may use knowledge stored in databases of intruder patterns and tactics in order to stop the intruders. Likewise, the enterprise may seek to protect enterprise assets, such infrastructure (e.g., office buildings, etc.) owned by the enterprise using a security guard. The security guard uses his or her knowledge and experience in order to stop intruders. For example, a security guard standing night watch on an office building may encounter an employee entering the office building. The security guard may recognize the employee as someone who IS regularly working during the day, and never visiting at night. Also, the security guard may notice that the employee is behaving abnormally, and is accompanied by an unknown person who is standing in close physical proximity to the employee. The security guard draws upon his or her past experience and knowledge, realizes that something is wrong, and responds appropriately.

Aspects of the invention involve protecting both computer network resources of an enterprise and physical systems and infrastructure of the enterprise. The invention relates to an Integrated Security Administrator (ISA) for managing and/or protecting information and assets of an enterprise's Informational Network (IN). The IN includes both one or more computer networks, and one or more physical access systems that are used to protect infrastructure, e.g., buildings, etc., associated with the enterprise. A physical access system may include smart building alarm/security systems, telephone networks and associated components (e.g., a Private Branch Exchange (PBX)), personal electronics devices (e.g., a Personal Digital Assistant (PDA)), smart cards and smart card readers, laptops, and other mobile personal electronics devices, biometrics devices, GPS-enabled devices, motion detectors, door position indicators, elevator controls and instrumentation, biometric devices, and software associated with the foregoing components of the IN.

The ISA may also interact with external entities, such as managed services, which are focused on certain aspects of the IN. For example, managed services may include computer security, operating system updates and patches, physical access monitoring, vulnerability to hacker attacks (such as port scanning), and managed services focusing on computer network security components (such as firewalls and IDS's). Components of the ISA may be geographically separated (e.g., on different continents), and connected using multiple communications means (e.g., satellite links, WAN's, etc.) for communications purposes.

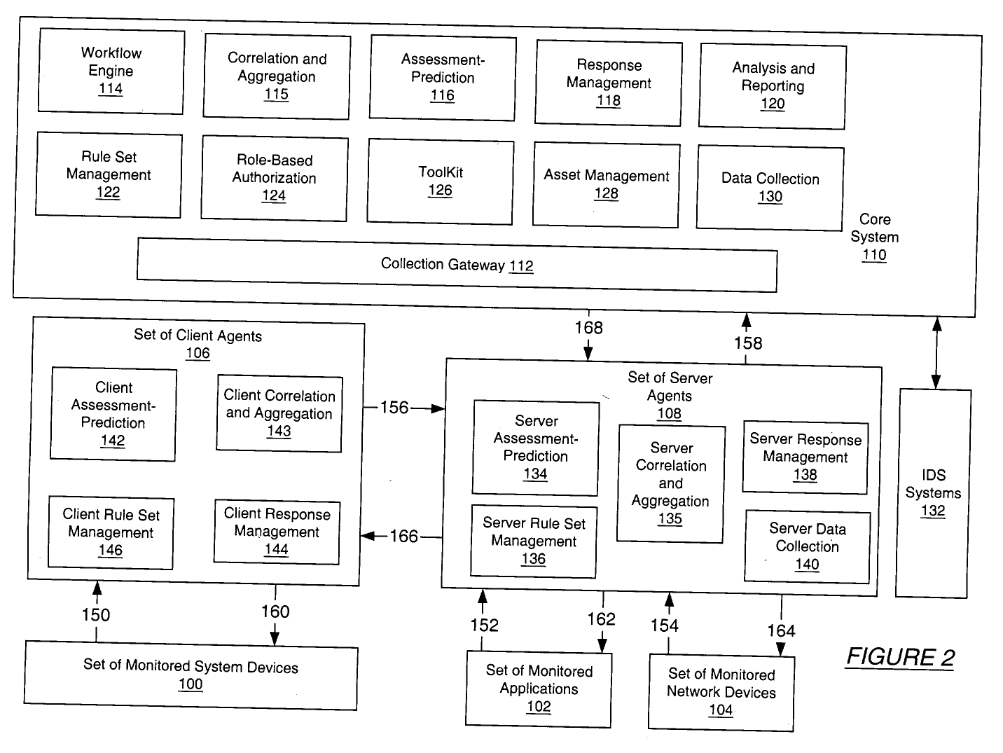

FIG. 2 shows components of the ISA in accordance with an embodiment of the invention. The ISA includes one or more monitored elements, which may be categorized as a set of monitored system devices (100), a set of monitored applications (102), and a set of monitored network devices (104). The set of monitored system devices (100) include laptops, workstations, process control systems, PDA's, etc. Examples of monitored applications (102) include Enterprise Resource Planning (ERP) software, databases, patch management software, enterprise asset management software, virus detection software, etc. Examples of monitored network devices (104) include routers, servers, firewalls, intrusion detection systems, etc.

In accordance with an embodiment of the invention, the ISA includes monitoring agents to monitor the monitored elements. The monitoring agents includes a set of lightweight (i.e., software with less-than-full functionality and low memory requirements) monitoring devices, such as a set of client agents (106), which receives data collected from the set of monitored system devices (100). The monitoring agents also include a set of heavyweight (i.e., software with full functionality and less-restricted memory requirements) monitoring devices, such as a set of server agents (108), which receives data collected from the set of monitored applications (102) and the set of monitored network devices (104). In the event of system failure, the lightweight monitoring devices may lose current monitoring data. However, the heavyweight monitoring devices, in accordance with an embodiment of the invention, have the capability to maintain stored monitoring data in the event of system failure.

A core system (110) includes functionality and back-end support to handle communications with the set of server agents (108) and the set of client agents (106) via the set of server agents (108). In accordance with an embodiment of the invention, functionality of the core system (110) is divided into multiple sub-components and is facilitated by an abstraction layer. The abstraction layer is denoted as the collection gateway (112). The collection gateway (112) provides a common interface between the various monitoring agents (e.g., the set of server agents (108) and the set of client agents (106)) and handles any implementation differences that may arise between the monitoring agents and the core system (110).

The core system (110) may include the following sub-components: a workflow engine component (114), a correlation and aggregation component (115), an assessment-prediction component (116), a response management component (118), an analysis and reporting component (120), a rule set management component (122), a role-based management component (124), a toolkit component (126), an asset management component (128), and a data collection component (130). The workflow engine component (114), the rule set management component (122), and the data collection component (130) represent stored knowledge used by the ISA to respond to events on the IN appropriately.

The workflow engine component (114) provides a mechanism for defining steps and/or sequences of steps that the ISA may take in response to a given event detected in association with a monitored element. For example, a laptop may be have been logged in by a user at a first location, which is an authorized location, as determined by enterprise policy. However, if the laptop is subsequently logged in at a second, unauthorized location, the ISA may respond with an appropriate action, such as invoking a Remote Procedure Call (RPC) to shutdown the laptop, and the workflow engine component (114) includes steps used to invoke the RPC.

In accordance with an embodiment of the invention, the workflow engine component (114) is pre-defined. Alternatively, the workflow engine component (114) may be fully defined by the user and/or modified by the user, according to the user's role (i.e., according to whatever level of authorization the user has been granted, and which is commensurate with the user's role).

The correlation and aggregation component (115) is used to combine a series of events that are judged to be similar (for example, because of their source or destination address, the location at which they occur, or the type of attack captured by the event) into one single aggregated event. This judgment may be pre-determined, or part of a user-defined rule-set. In addition, the correlation and aggregation component uses information from various enterprise databases, in conjunction with the event itself, to make intelligent recommendations on the threat posed to the enterprise and direct the response management component to take appropriate actions. The correlation and aggregation component (a) correlates physical security and network security events to provide a holistic view of enterprise security; (b) correlates network security events against existing vulnerability information to perform an accurate impact and risk analysis; (c) correlates network security events against enterprise asset management software to aid in incident management; and (d) may optionally interface with any enterprise database to perform appropriate rule-based correlation.

The assessment-prediction component (116) is used to characterize an event or sequence of events against predefined monitoring and response rules maintained in the rule set management component (122). In order to evaluate the sequence of events against the predefined monitoring and response rules, the assessment-prediction component (116), in accordance with an embodiment of the invention, may use appropriate mathematical techniques, such as Bayesian mathematics.

The response management component (118) directs the response action that the ISA may take based on the characterization of events by the assessment-prediction component (116). The response management component (118) performs the appropriate action based on definitions and sequences of actions defined in the workflow engine component (114). Alternatively, the response management component (118) may be fully defined by the user and/or modified by the user, according to the user's role (i.e., according to whatever level of authorization the user has been granted, and which is commensurate with the user's role).

As noted above, the assessment-prediction component (116) categorizes an event or sequence of events based on a set of rules. The sets of rules are defined in the rule set management component (122). In particular, the rule set management component (122) defines the monitoring and response actions for the ISA and may be used to enforce information network policy and/or security policy for the enterprise. The sets of rules may be predefined, or, alternatively, the sets of rules may be defined and/or modified by the user.

The role-based authorization component (124) defines the roles taken on by users of the IN. The definition of a role includes determining which actions the user is allowed to perform with respect to components of the IN. For example, the role-based authorization component (124) perform provisioning functions, such as defining a Chief Executive Officer (CEO) role and a typist role, such that the CEO is able to access sales reports, and the typist is not able to access the sales reports.

Additionally, the definition may also include the tasks the user may perform. In accordance with an embodiment of the invention, once the user has logged onto the IN, the ISA assigns the user a role and subsequently insures that the user is restricted to access only those actions designated for that role. Additionally, the ISA may maintain an information history of the roles that a user has been assigned to in the past and the role(s) the user is currently assigned. In accordance with an embodiment of the invention, a user may be assigned more than one role.

The analysis and reporting component (120) provides tools to review and synthesize the data collected by the ISA. For example, in accordance with an embodiment of the invention, multi-sensor data fusion techniques may be used by the analysis and reporting component (120).

In accordance with an embodiment of the invention, reports may be generated by the analysis and reporting component (120) for the IN as a whole. Alternatively, reports may be generated for particular subsets of the IN, such as particular geographic locations, particular monitoring agents, etc. Further, in some cases, the ISA may be configured to generate reports automatically using predefined reporting formats. In accordance with an embodiment of the invention, the analysis and reporting component (120) includes the ability to use multi-sensor data fusion techniques. The data used to generate the reports is provided by a data collection component (130).

The data collection component (130) provides a persistent data store of the ISA. In particular, the data collection component (130) may include information obtained from the monitoring agents, ISA configuration information, and metadata required to operate the ISA. In accordance with an embodiment of the invention, the information stored in the data collection component (130) is encrypted. Data stored in the data collection component (130) may include data previously collected from the monitored elements, which, when analyzed by the components of the ISA, characterizes the previous operational history of the monitored elements, e.g., serves as a behavioral database for components of the IN.

The asset management component (128) is used to maintain information that associates the monitored elements (e.g., components of the infrastructure) with a specific user and/or a specific topology (e.g., floors of an office building) or geographical location of the IN. For example, a history of geographical and/or topological locations over a period of time may be maintained by the ISA for a specific user or asset, or combination of both a user and an asset. For example, a history of geographical locations for a particular user and a particular laptop assigned to the user may be maintained.

Such information maintained by the asset management component (128) may be used to detect potential misuse of a particular asset or other potential incidents. For example, when the user mentioned in the previous example was assigned the laptop, the user may have been informed that he/she should not take the laptop away from the confines of a particular location, such as a particular office building. If the laptop is Global Positioning System (GPS)-enabled, then the ISA may determine, using the assessment management component (128), that the laptop has been moved to an inappropriate location. Further, if a user attempts to log onto a computer network from two physical locations at approximately the same time, the ISA recognizes a possible security breach.

The toolkit component (126) provides the necessary tools to create new components, integrate third-party software into the ISA, define additional monitoring agents, etc. For example, the toolkit component (126) may include software that includes a Graphical User Interface (GUI) front-end for interfacing with a user, and a back-end configured to communicate with popular third-party software using appropriate protocols and Application Programming Interfaces (API's). In accordance with an embodiment of the invention, code generation software tools may also be included in the toolkit component (126) for generating new components of the IN and/or the ISA, additional monitoring agents, etc.

Each server agent of the set of server agents (108) includes a server assessment-prediction component (134), a server correlation and aggregation component (135), a server rule set management component (136), a server response management component (138), and a server data collection component (140). In accordance with an embodiment of the invention, components of each server agent are typically subsets of the corresponding components in the core system (110). Furthermore, components in each server agent may be specific to the server agent and the corresponding monitored application of the set of monitored applications (102), or the corresponding monitored network device of the set of monitored network devices (104), which the server agent is monitoring.

For example, the server rule set management component (136) on a particular server agent may include rules that are associated with a particular corresponding monitored application, or corresponding monitored network device, as the case may be. For example, a first server agent may be monitoring a firewall, and a second server agent may be monitoring a security application. Therefore, the server rule set management component (136) of the first server agent may be configured specifically for the firewall, and the server rule set management component (136) of the second server may be configured specifically for the security application.

Each server agent maintains monitoring information locally in the server data collection component (140), and also sends a copy of such monitoring information to the data collection component (130) of the core system (110). When certain core system (110) sub-components, such as the rule set management component (122), are updated, the corresponding component in each server agent is also updated. The updating of the components in each server agent may be performed using a push model or a pull model.

If the connection between a server agent and the core system (110) is disrupted, the server agent may function autonomously until the connection is restored. Once the connection is restored, the information stored in the server data collection component (140) of the server agent may be re-synchronized with the data collection component (130) in the core system (110). In accordance with an embodiment of the invention, the connection between the core system (110) and each server agent is encrypted.

Each server agent is located on (i.e., loaded into RAM and executing), or is connected to, a server or network device which the particular server agent is monitoring. For example, a first server agent may be monitoring a firewall, and is installed and executing upon the same computer upon which the firewall installed and executing. In accordance with an embodiment of the invention, each server agent may be used to network together devices such as web servers, firewalls, routers, PBX's, etc.

Each client agent of the set of client agents (106) includes a client assessment-prediction component (142), a client correlation and aggregation component (143), a client response management component (144), and a client rule set management component (146). The components of each client agent are subsets of the corresponding components in the core system (110). In particular, components in each client agent are specific to the client agent and the corresponding client device, which the client agent is monitoring. For example, the client rule set management component (146) on a particular client agent includes rules that are associated with the corresponding client device.

Further, each client agent is associated with a particular server agent of the set of server agents (108). In particular, data collected by a client agent is initially stored on an associated server agent prior to being sent to the core system (110). Thus, if a connection between the server agent and the client agent is disrupted, the data collected is lost. For purposes of redundancy, a particular client agent may also be directly connected to the core system (110) (not shown). In accordance with an embodiment of the invention, client agents are located on client devices of the set of monitored system devices (100). Alternatively, client agents are located on a network device connected to a specific monitored system device of the set of monitored system devices (100). In accordance with an embodiment of the invention, the core system (110) may also be connected to one or more IDS's (132) (not shown).

Each component of the ISA may further include a series of sub-components. In accordance with an embodiment of the invention, the core system (110) and all sub-components ((112), (114), (115), (116), (118), (120), (122), (124), (126), (128), and (130)) are located on a dedicated server in the IN. Alternatively, the core system (110) and associated sub-components ((112), (114), (115), (116), (118), (120), (122), (124), (126), (128), and (130)) are distributed across a number of servers in the IN.

Communication between the core system (110) and the set of client agents (106), the set of server agents (108), the set of monitored system devices (100), the set of monitored applications (102), and the set of monitored network devices (104) is implemented using data collection channels (150, 152, 154, 156, and 158), and response action channels (160, 162, 164, 166, and 168). In one or more embodiments of the invention, communication between components of the ISA is conducted through encrypted data lines. Those skilled in the art will appreciate that while the core system (110) has been defined as having numerous components, not all components need be included in every implementation of the invention.

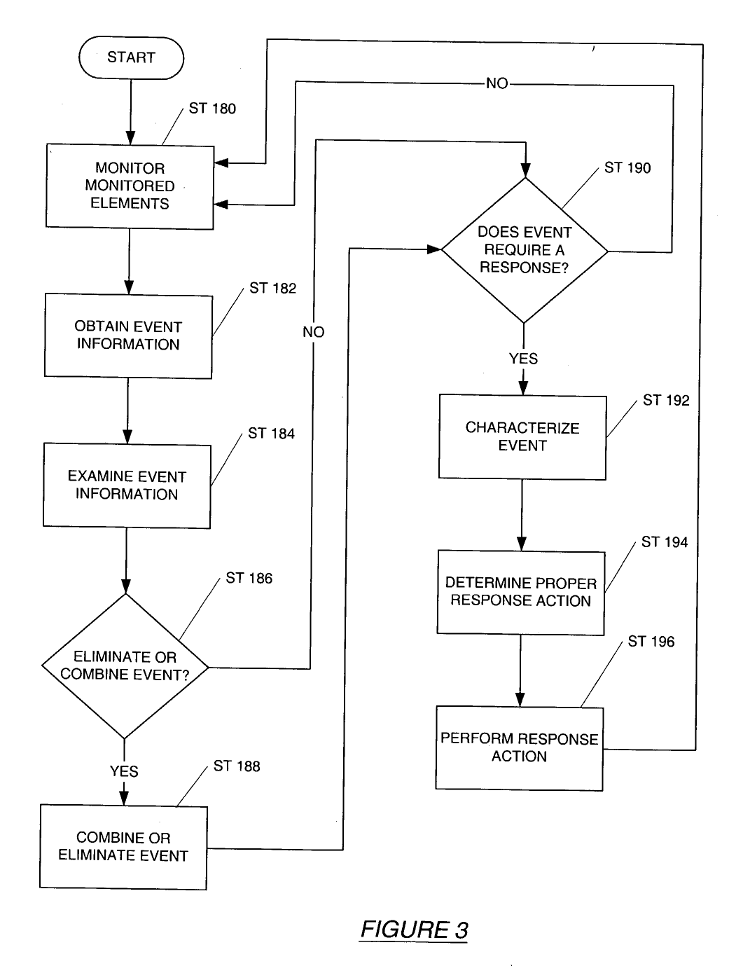

FIG. 3 illustrates a flow chart illustrating operation of the ISA, in accordance with one embodiment of the invention. Initially, monitored elements (e.g., workstations, firewalls, smart card readers, etc.) are monitored by monitoring agents, i.e., server agents and client agents, and/or managing services (Step 180). When an event (or events) associated with a particular monitored element, e.g., a web server, occurs, a monitoring agent, such as a server agent, or a managing service, obtains event information (Step 182). For example, the server agent may monitor accesses to the web server, file and configuration changes made to the web server, or accesses to a particular door in an office building, etc. Such event information may be obtained using data collected from log files, SNMP traps, packet sniffers, a smart card reader, etc.

Next, the event information is examined to determine event significance (Step 184). Examination of the event information may be performed by the assessment-prediction component, which consults with the rule set management component, and the correlation and aggregation component. For example, every day, hundreds of people will use a smart card to access a door, and hundreds of port scans may be performed against a computer network. However, certain of the events may be eliminated from a set of events obtained. For example, a Windows attack against a Unix computer may be eliminated from the set of events because it is an effectual attack. A significance criteria or criterion-may be used to determine whether the event is significant or insignificant. A determination is then made as to whether the event is suitable for aggregation or elimination (Step 186). Typically, numerous events will be obtained every day from the IN. However, events associated with similar attacks or attackers coming from the same source may be combined into a single event if the similar attacks meet a similarity criterion (e.g., associated with the same Internet Protocol (IP) address, etc. Thus, by elimination and aggregation, the set of events is reduced to obtain a reduced set of events. If the event is suitable for aggregation or elimination, the event is eliminated, or multiple events are combined into a single event (Step 188). The correlation and aggregation component is used to both determine whether an event may be eliminated or combined, and to combine the event with other events.

A determination is then made as to whether the event, as characterized by the assessment-prediction component, requires a response (Step 190). The assessment-prediction component is used to characterize the event using monitoring and response rules maintained in the rule set management component. For example, a prediction may be made that a particular event is not harmful. If no response is required, monitoring of the monitored element continues (Step 180). Otherwise, the assessment-prediction component characterizes the event (or events) for the response management component (Step 192). Rules that define how to characterize the event are defined in the associated rule set management component of the monitoring agent. For example, if the event is a series of port scans that the enterprise's information security personnel have determined is indicative or predictive of an attempted hacking, the rule set management component may deem the event significant.

Then, the response management component consults with the workflow engine component to determine a proper response action for the event (Step 194). For example, the workflow engine component may define a series of steps for invoking an RPC in order to shut down the monitored element. Once the response action has been determined (e.g., invoking the RPC to shut down the monitored device), the workflow engine component forwards the necessary information (e.g., steps to invoke the RPC) to the response management component to perform a response action for the event (Step 196).

The response management component may respond to an event or set of events at one of several levels, including inform level, enforce level, or prevent level. At the inform level, the response management component directs the response action to appropriate ISA personnel, e.g., an analyst, for evaluation and for possible amendment of the rule set management component and/or the workflow management component to improve the response of the ISA should the event (e.g., the port scanning) re-occur. Thus, the ISA aids in a continuous learning effort to maximize its performance on behalf of the enterprise.

At the enforce level, the response management component has identified a need to enforce compliance with one or more predefined policies of the enterprise. The response management component then takes direct action to enforce compliance with enterprise policy. For example, the ISA may detect that a password or other system secret has not been changed within a prescribed period. In accordance) with an embodiment of the invention, the ISA takes an action to insure that the password is changed. For example, the ISA may prevent a user associated with the password from logging onto the IN until the password is changed.

Once the response action has been performed, monitoring of the monitored elements continues (Step 180). In accordance with an embodiment of the present invention, a response action(s) at the prevent level is taken in real time to prevent a subsequent event associated with the event. Using a predefined workflow for such occurrences, the response management component acts to prevent in real time a perceived threat associated with the subsequent event. For example, if the ISA detected a first event determined to be associated with an intrusion in progress on the monitored element, the ISA could act to shut down the monitored device to prevent the subsequent event, and thereby prevent the subsequent event. In accordance with an embodiment of the invention, further investigation of the event and is accomplished by an appropriate analyst(s) of the enterprise.

Because the client agents and the server agents include subsets of functionality of the core system, operations shown in FIG. 3 may be performed on either a client agent, a server agent, or the core system, or any combination of the foregoing. Furthermore, although not shown on FIG. 3, other operations may be performed in association with the operations of FIG. 3. For example, data relating to events obtained, and responses performed, by the client agents and server agents may be transferred to the core system for analysis and/or storage.

Three scenarios are provided below to show an example of how the ISA may operate to protect information, computer networks, infrastructure, resources and assets associated with the IN:

The first scenario involves a person entering a building associated with the enterprise in London using a smart card with an associated number of “12345.” A first log entry is then recorded and sent to the ISA indicating that smart card number “12345” has entered a location L (e.g., London). Shortly thereafter, username “joe” logs into a computer in location H (e.g., Houston). A corresponding second log entry is recorded and sent to the ISA. The ISA performs the following events upon receiving the second log entry: (1) the analysis and reporting component queries a corporate user database to retrieve information about the username “joe”, including his physical location (e.g., Houston) and smart card number (e.g., 12345); (2) the correlation and aggregation component analyzes the first log entry to determine whether an inconsistency exists between the logical access (i.e., the computer login) and the physical access (i.e., entering a particular location); (3) the analysis and reporting component determines that username “joe” with smart card number “12345” cannot simultaneously be in both location L and location H, and initiates an alert sequence.

Next, the response management component may take further actions, such as configuring a network device to capture traffic from the suspect machine, blocking the user from accessing the building until the issue has been resolved, or denying network access to the computer being accessed by “Joe.” Similarly, the ISA is able to detect fraudulent use of physical access tokens, such as when an employee has been terminated; however, physical access attempts from his/her card may still be detected at the location.

A second scenario involves an organization being targeted by a hacking attack, in which hundreds of attacks are observed every hour. Instead of displaying all of these hundreds of attacks on a computer monitor for a systems administrator, the correlation and aggregation component identifies similar attacks and merges them into a single aggregated attack event (thus reducing the amount of data to view). The correlation and aggregation component also identifies common attack sources and merges them into a single correlated attack event (further reducing the amount of data to view). Thus, the system administrator may easily comprehend the attack, which would otherwise may appear to be disparate, unrelated events.

The analysis and reporting component performs computations to judge impact, the risk of future attacks, and interface with the response management component to reconfigure the IN accordingly (e.g., block designated hosts at the firewall). The correlation and aggregation component and the analysis and reporting component interface with enterprise databases, such as a patch management database, and a security vulnerability database (which contains the most recent information about a monitored element's security status), and are able to infer whether the attack is really serious or not (e.g., a Windows attack against a Unix host is completely innocuous). This further reduces extraneous data analysis, and ensures that the system administrator views only data that is of immediate threat to the enterprise.

A third scenario involves a situation where an enterprise's computer network firewalls and IDS's receive hundreds of different attacks every day. In such a scenario, the ISA assists an administrator to recognize and react to coordinated attacks based on time, source address, or attack pattern. The correlation and aggregation component and the analysis and reporting component perform correlation of similar attacks and common attack sources. The response management component coordinates a single, distributed response that affects the monitored elements (e.g., the response may blacklist a known attacker and prevent access through every access point).

The invention has one or more of the following advantages. The invention provides an integrated set of management tools that allows a network administrator to securely consolidate and manage global information. In particular, the invention monitors adherence to established enterprise IN policies, centralizes management/monitoring/control of assets, provides localized network management when disconnected from the central system, detects, analyzes, and forecasts events, consolidates action/reaction to protect assets, enhances capacity and security management capabilities, escalates reactive actions to insure timely resolutions, etc. Further, the invention is easily extended to include new systems/devices.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. An Integrated Security Administrator (ISA) for managing an Informational Network (IN), comprising:
a plurality of monitoring agents, wherein at least one of the plurality of monitoring agents is configured to obtain a plurality of events from a plurality of monitored elements, reduce the plurality of events to obtain a reduced plurality of events, select an event from the reduced plurality of events, characterize the event using stored knowledge, and respond to the event at a response level; and
a core system configured to update data and instructions stored on the at least one of the plurality of monitoring agents.

2. The ISA of claim 1, wherein the response level is one selected from a group consisting of the following: an inform level, an enforce level, and a prevent level.

3. The ISA of claim 2, wherein the plurality of monitoring agents comprises a plurality of server agents and a plurality of client agents.

4. The ISA of claim 3, wherein the core system is configured to obtain the plurality of events, reduce the plurality of events to obtain the reduced plurality of events, select the event from the reduced plurality of events, characterize the event using the stored knowledge, and respond to the event at the response level.

5. The ISA of claim 4, wherein the core system comprises:
a correlation and aggregation component configured to reduce the plurality of events;
an assessment and prediction component configured to characterize the event using the stored knowledge;
an analysis and reporting component configured to interface with the stored knowledge and synthesize data associated with at least one of the plurality of events;
a response management component configured to manipulate the IN according to the response;
a workflow engine component defining a step of the response;
a rule set management component used by the response management component to maintain a rule embodying a security policy of an enterprise;
a role-based authorization component defining a role of a user of the IN;
a toolkit configured to add a monitored element to the plurality of monitored elements;
an asset management component maintaining information associating a user with the monitored element; and
a data collection comprising the stored knowledge.

6. The ISA of claim 5, wherein each of the plurality of client agents comprises:
a client correlation and aggregation component comprising a subset of the correlation and aggregation component;
a client assessment and prediction component comprising a subset of the assessment and prediction component;
a client response management component comprising a subset of the response management component; and
a client rule set management component comprising a subset of the rule set management component.

7. The ISA of claim 5, wherein each of the plurality of server agents comprises:
a server correlation and aggregation component comprising a subset of the correlation and aggregation component;
a server assessment and prediction component comprising a subset of the assessment and prediction component;
a server response management component comprising a subset of the response management component;
a server rule set management component comprising a subset of the rule set management component; and
a server data collection comprising a subset of the data collection.

8. The ISA of claim 5, wherein data related to the event is sent from one of the plurality of client agents to the core system via one of the plurality of server agents.

9. The ISA of claim 8, wherein the monitoring agent characterizes the event using information relating the user to a physical location.

10. The ISA of claim 8, wherein the monitoring agent characterizes the event using information relating the monitored element to a physical location.

11. The ISA of claim 8, wherein the monitoring agent characterizes the event by predicting future consequences of the event.

12. A method of protecting an Informational Network (IN) using a Integrated Security Administrator (ISA), comprising:
obtaining a plurality of events on the IN;
reducing the plurality of events to obtain a reduced plurality of events;
selecting an event from the reduced plurality of events;
characterizing the event using stored knowledge; and
responding to the event at a response level using a result of characterizing the event.

13. The method of claim 12, wherein the response level is one selected from a group consisting of the following: an inform level, an enforce level, and a prevent level.

14. The method of claim 13, wherein the stored knowledge embodies a security policy for an enterprise.

15. The method of claim 13, wherein responding to the event comprises manipulating a physical access system of the IN.

16. The method of claim 13, wherein responding to the event comprises manipulating a computer network of the IN.

17. The method of claim 13, wherein characterizing the event uses data relating to a physical location.

18. The method of claim 13, wherein characterizing the event comprises predicting future consequences of the event.

19. The method of claim 13, wherein reducing the plurality of events comprises removing one of the plurality of events.

20. The method of claim 19, wherein the one of the plurality of events is removed if the one of the plurality of events fails to meet a significance criteria.

21. The method of claim 13, wherein reducing the plurality of events comprises combining at least two events of the plurality of events into a single event.

22. The method of claim 21, wherein the at least two events are combined if the at least two events meet a similarity criteria.

23. An apparatus for protecting an Informational Network (IN) using a Integrated Security Administrator (ISA), comprising:
means for obtaining a plurality of events on the IN;
means for reducing the plurality of events to obtain a reduced plurality of events;
means for selecting an event from the reduced plurality of events;
means for characterizing the event using stored knowledge; and
means for responding to the event at a response level using a result of characterizing the event.
